(19) United States
(12) Patent Application Publication
(10) Pub. No.: US 2020/0352090 A1
(43) Pub. Date: Nov. 12, 2020

(54) RAKE HAVING A SPADE IMPLEMENT

(71) Applicant: Kyle Wilson, Salt Lake City, UT (US)

(72) Inventor: Kyle Wilson, Salt Lake City, UT (US)

(21) Appl. No.: 16/849,992

(22) Filed: Apr. 15, 2020

Related U.S. Application Data
(60) Provisional application No. 62/920,637, filed on May 10, 2019.

(51) Int. Cl. A01D 7/06; A01B 1/20

(52) U.S. Cl. CPC A01D 7/06; A01B 1/20

(57) ABSTRACT

A rake may have a spade implement disposed adjacent to the tines. The spade implement may have a thin or sharpened edge and may have a convex edge running from the top to the bottom to facilitate the spade implement cutting portions of plants or of cutting into the ground to facilitate the removal of plants, rocks, etc. The spade implement may be welded or otherwise attached to one of the tines of the rake head, or may be formed integrally therewith.

### BACKGROUND

### State of the Art

The present invention relates to a rake having a spade implement.

### Field of Art

There are a variety of uses for rakes and the like. When taking care of a landscape, a rake may be used to spread material, such as bark and gravel. A rake may also be used to remove vegetation—whether alive or dead. Leaves may be raked out of flower beds and overgrowth may be cleared. Rakes may also be used to remove weeds or other plants.

While raking it is often desirable to remove items. For example, while spreading bark, a gardener may come across a weed. If the tines of the rake are unable to pull out the weed, the gardener will often turn the rake sideways and attempt to use the outer edge of the outermost tine to cut the root of the weed so that the weed may be removed. Because the side edges of the rake are generally flat, considerable force may be necessary to sever the root of the weed with the blunt surface.

Likewise, while raking a person may come across a partially buried rock or other structure which needs to be removed. While the gardener may elect to put down the rake and get a shovel, this will often take additional time and a shovel may not be available. Thus, the gardener may attempt to dig out the rock, etc. Again, this is typically done by turning the rake sideways and using the blunt side edge of the outermost tine to dig out the rock.

While using the side of the rake to cut the roots of weeds or to dig out rocks, etc., which saves time from switching tools, it tends to be damaging to the rake. The repeated impacts to the side of the rake tends to break the weld which is used to connect the rake head to the rake handle. Likewise, the outmost tine of the rake may be bent or may break due to the repeated impacts.

Thus, there is a need for an improved rake which can be used to cut roots and remove rocks with less damage to the rake.

### SUMMARY OF THE INVENTION

The following summary of the present invention is not intended to describe each illustrated embodiment or every possible implementation of the invention, but rather to give illustrative examples of application of principles of the invention.

In accordance with one aspect of the disclosure, a rake may be provided with a spade portion which may be used to cut roots or remove rocks and other items with less damage to the rake.

In one embodiment, a spade is added to a rake head adjacent an outermost tine of the rake head.

In one embodiment, an outermost tine of the rake head may be made larger and with a convex side such that the outermost tine forms a spade on the side of the rake.

In one embodiment, the spade may be rounded across its width.

### BRIEF DESCRIPTION OF THE DRAWINGS

Various embodiments of the present disclosure are shown and described in reference to the numbered drawings wherein:

FIG. 1 illustrates a front view of a rake formed in accordance with principles of the present disclosure;

FIG. 2 shows an end view of a rake made in accordance with principles of the present disclosure;

FIG. 3 shows an end view of another embodiment of a rake;

FIG. 4 shows an end view of another embodiment of a rake;

FIG. 5 shows an end view of another embodiment of a rake;

FIG. 6 shows a side view of a rake made in accordance with principles of the present disclosure; and

FIG. 6A shows a cross-sectional view of tine 20a in FIG. 6 taken along the line A-A.

It will be appreciated that the drawings are illustrative and not limiting of the scope of the invention, which is defined by the appended claims. The embodiments shown accomplish various aspects and objects of the invention. It will be appreciated that it is not possible to clearly show each element and aspect of the present disclosure in a single figure, and as such, multiple figures are presented to separately illustrate the various details of different aspects of the invention in greater clarity. Similarly, not all configurations or embodiments described herein or covered by the appended claims will include all of the aspects of the present disclosure as discussed above.

### DETAILED DESCRIPTION

Various aspects of the invention and accompanying drawings will now be discussed in reference to the numerals provided therein so as to enable one skilled in the art to practice the present invention. The skilled artisan will understand, however, that the methods described below can be practiced without employing these specific details, or that they can be used for purposes other than those described herein. Indeed, they can be modified and can be used in conjunction with products and techniques known to those of skill in the art in light of the present disclosure. The drawings and the descriptions thereof are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Reference in the specification to “one embodiment,” “one configuration,” “an embodiment,” or “a configuration” means that a particular feature, structure, or characteristic described in connection with the embodiment may be included in at least one embodiment, etc. The appearances of the phrase “in one embodiment” in various places may not necessarily limit the inclusion of a particular element of the invention to a single embodiment, rather the element may be included in other or all embodiments discussed herein.

Furthermore, the described features, structures, or characteristics of embodiments of the present disclosure may be combined in any suitable manner in one or more embodiments. In the following description, numerous specific details may be provided, such as examples of products or manufacturing techniques that may be used, to provide a thorough understanding of embodiments of the invention. One skilled in the relevant art will recognize, however, that embodiments discussed in the disclosure may be practiced without one or more of the specific details, or with other methods, components, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein, but is extended to include equivalents thereof as would be recognized by those of ordinarily skill in the relevant art. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such aspect is required to be present apart from an express inclusion of that aspect in the claims.

It should also be noted that, as used in this specification and the appended claims, singular forms such as “a,” “an,” and “the” may include the plural unless the context clearly dictates otherwise. Thus, for example, reference to “a bracket” may include an embodiment having one or more of such brackets, and reference to “the target plate” may include reference to one or more of such target plates.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing the nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “generally” refers to something that has characteristics of a quality without being exactly that quality. For example, a structure said to be generally vertical would be at least as vertical as horizontal, i.e., would extend 45 degrees or greater from horizontal. Likewise, something said to be generally circular may be rounded like an oval but need not have a consistent diameter in every direction.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

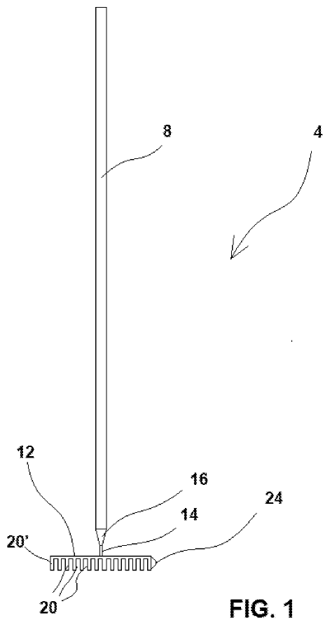

Turning now to FIG. 1, there is shown a front view of a rake, generally indicated at 4. The rake 4 may include a handle 8 and a head 12 which are held together with an arm 14 and a ferrule 16. The ferrule 16 may help to keep the distal end of the handle 8 from splitting and ensures a secure grip on the arm 14.

The head 12 may include a plurality of tines 20, only some of which are labeled in FIG. 1. Disposed on one of the outermost tines is a spade implement 24 which may be welded or otherwise attached to the outermost tine. The spade implement 24 may also be attached directly to some other portion of the head 12, such as by welding, etc. Rather than providing a blunt, relatively flat surface as shown on the opposing outermost tine 20′, the spade implement 24 is convex extending away from the tines 20. The convex surface provides an implement wherewith a gardener, or the like, can cut the roots of weeds or dig in the dirt to lift out rocks and other material which the gardener wants to remove. Because of the convex surface, the spade implement will dig through the soil with less effort than the conventional outermost tine 20′. This allows the gardener, etc., to use less force when removing weeds or rocks, reducing the force on the head and ultimately extending the life of the rake.

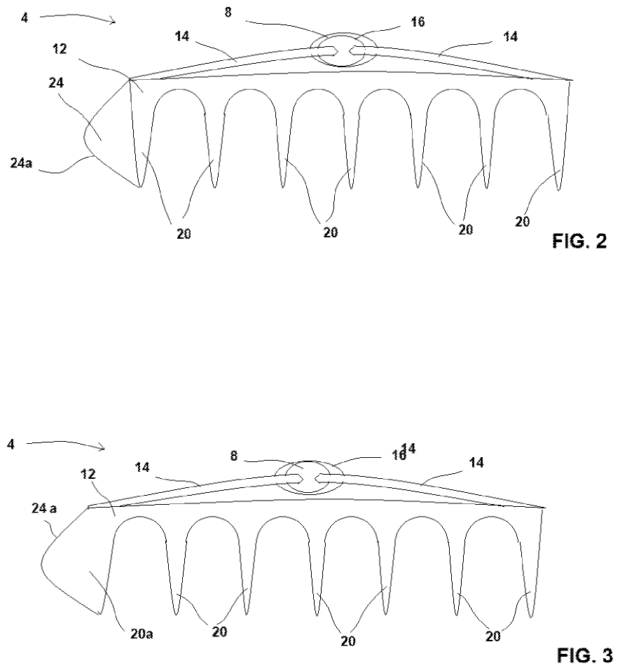

Turning now to FIG. 2, there is shown an end view of a rake. Rather than using a single arm 14 to connect the head 12 to the handle 8, two arms or braces 14 are used. This is commonly referred to as a bow rake. The arms 14 have a connecting portion which is inserted into the handle 8. Opposing ends of the arms are typically welded to the head 14.

The head 12 in FIG. 2 includes a plurality of tines 20. Disposed on one of the outermost tines is the spade implement 24. The spade implement 24 includes a broadly rounded convex outer edge 24a extending from the top to the bottom which extends outwardly from the outermost tine. Ideally, the spade implement 24 is 2-10 times as wide at its widest point as the tine, with a more preferable width being 3-6 times the width of the tine, and ideally being 4-5 times the width to the tine. The spade 24 implement may be welded to the tine 20 along a side of the space implement generally opposite the convex outer edge 24a. Alternatively, the spade implement may be welded or otherwise attached to some other portion of the head or to one of the arms 14.

As an alternative to welding or otherwise attaching the spade implement 24 to the outermost tine 20, the spade implement and the outermost tine can be formed as an integrated piece, such as outermost tine 20a shown in FIG. 3. The outermost tine 20 has a broadly rounded outer edge 24a so that the width of the outermost tine 20 at its widest is between 2 and 10 times the width of the other tines, and preferably between 3-6 times the width of the other tines. The broadly rounded outer edge (from top to bottom) 24a facilitates cutting into the soil, such as when needed to cut the root of a weed, or to cut a rock out from the ground. Less force is needed than if the opposing outermost tine were to be used with its generally flat lateral side. This reduces wear and tear on the rake 4, prolonging its useful life while also making the rake more convenient to use.

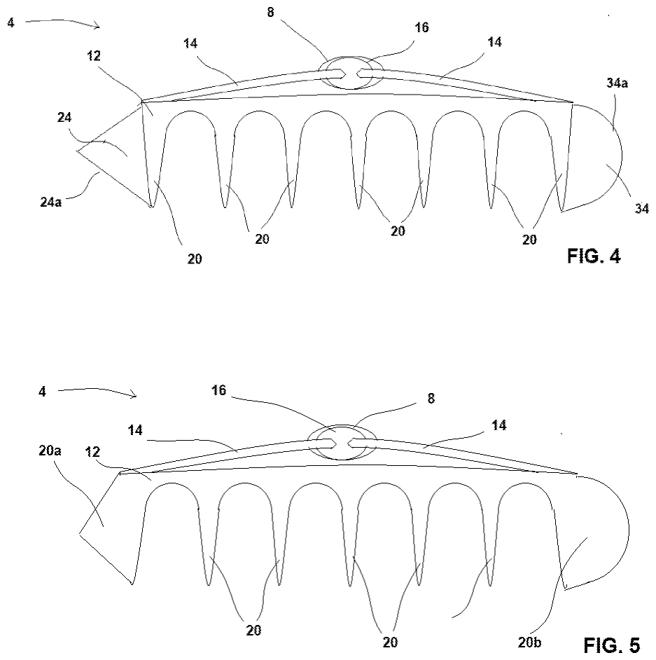

Turning now to FIG. 4, there is shown a rake, generally indicated at 4. As with the other rakes, the rake 4 may include a handle 8 and a head 12, which may be held together by one or more arms 14 and a ferrule 16 on the bottom of the handle. The head 12 may include a plurality of tines 20 which extend downwardly with voids between them. On the outermost tine 20 on the left, a spade implement 24 may be attached such as by welding or some other attachment process. The spade implement 24 may be somewhat triangular as it extends from the tine so that its widest point is roughly in alignment with the middle of the tine when measured by length. Such a spade implement is designed to more easily cut through the root of a large weed.

On the opposing outermost tine 20, a second spade implement 34 may be attached either adjacent to or directly to the tine. The spade implement 34a may be more broadly rounded, i.e., it may be semi-circular or similar. In such a configuration, the space implement 34 may be designed for use in softer dirt, where the spade implement is designed to move more soil while being less penetrating than the more pointed design of spade implement 24. Thus, for example, the spade implement 34 may be used to more quickly dig around a rock sufficiently that the rock can be removed from the soil.

Turning now to FIG. 5, there is shown an alternate rake 4 made in accordance with principles of the present disclosures. The rake 4 may include a handle 8 and ferrule 16 along with one or more arms 14 for connecting the handle to the head 12. The head 12 may include a plurality of tines 20. One outermost tine 20a may be considerably wider than the middle tines 20, such as 2-10 times and preferably 3-6 times wider near a midpoint when measuring top to bottom. The outermost tine 20a on the left side may form a spade implement with a shaped lateral edge (shown here to be generally triangular), so as to improve penetration in to the soil when the rake is rotated so that the tine 20a is on the bottom and used to strike or be pushed into the ground. Thus, for example, if a gardener comes upon a large weed, the gardener may either strike at the base of the weed with the more pointed portion of the tine 20a to cut off the weed. Alternatively, the tine 20a may be placed against the soil and the gardener may stop on the opposing side of the rake to drive the tine into the soil and then the handle can be used to lever the head 12 back so that the tine helps pull the roots of the weed from the soil.

The opposing outermost tine 20b may also include a spade implement as part of the tine. As shown in FIG. 5, the spade implement is broadly rounded so as to move more soil, such as might be done when removing soil to take out a rock, or lifting soil to enable small weeds to be pulled so their roots are also extracted. While the spade implements in FIG. 5 could be welded to existing tines, the entire head 12 could be forged or cast so as to be a single piece.

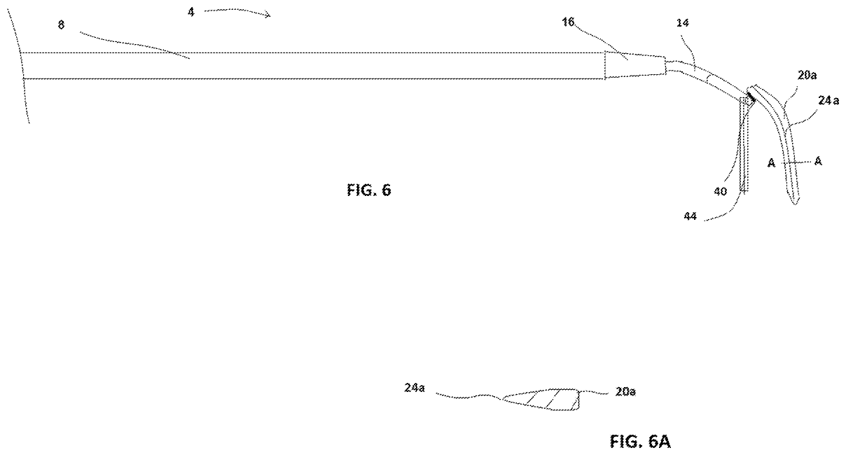

Turning now to FIG. 6, there is shown a side view of a rake, generally indicated at 4. The rake 4 may include a handle 8, a ferrule 16, one or more arms 14 and a head 12. The head 12 may be attached to the one or more arms 14 by a weld 40. The outermost tine 20A which forms a spade implement may be seen. The tine 20a may be tapered along its outside edge 24a so as to form a sharp or thin edge 24a between the front and back surface as shown in FIG. 6A. The sharp/thin edge 24a facilitates the spade implement cutting into soil and severing plant roots and the like.

As shown in FIG. 6, the tines 20 may be rounded or curved (which may cause the spade implement to likewise be curved on the front and/or back surfaces). Also shown in FIG. 6 is a second spade implement 44 with a sharp edge 44. While the spade implement may be attached to the tines and discussed above, it is also possible to have the spade implement 44 attached to at least one arm.

Regardless of which embodiment is used, the rakes discussed herein allow a person to use the rake as a conventional rake and to use the rake as a spade to cut plant roots and/or to cut through soil to remove rocks and the like. The spade implement can be used simply by rotating the rake and swinging the head so that the spade implement contacts the roots or soil. Alternatively, it can be used by placing the spade implement against the plant or soil and stepping on the opposing end with one's foot. Thus, the functionality of the rake with a spade implement is enhanced. Additionally, because less force is needed due to the tapered edge of the spade implement, the rake typically will last longer.

Thus, there is disclosed a rake having a spade implement. Those skilled in the art will appreciate numerous modifications which can be made within the scope and spirit of the invention. The appended claims are intended to cover such modifications.

What is claimed is:

1. A rake comprising:
a handle,
a head attached to the handle, the head having a plurality of tines; and
a spade implement attached to the head.

2. The rake according to claim 1, wherein head has two outermost tines and wherein the spade implement is attached to one of the outermost tines.

3. The rake according to claim 2, wherein the spade implement is welded to one of the outermost tines.

4. The rake according to claim 1, wherein the spade implement is generally triangular in shape.

5. The rake according to claim 1, wherein the spade implement is generally semicircular in shape.

6. The rake according to claim 1, wherein the spade implement is tapered to a narrow outer edge.

7. The rake according to claim 1, wherein the spade implement is formed integrally with one of the outermost tines.

8. The rake according to claim 1, wherein the rake has a second spade implement attached to one of the outermost tines.

9. The rake according to claim 1, wherein the spade implement has a front side and a back side and wherein the spade implement is curved on at least one of the front side and the back side.

10. The rake according to claim 1, wherein the tines has an average width and wherein the spade element is at least twice as wide at the spade element's widest point than the tines.

11. The rake according to claim 10, wherein the spade element is at least 3 times as wide as the tines at its widest point.

12. A rake comprising:
a handle;
at least one arm attached to the handle;
a head attached to the at least one arm, wherein the head has a plurality of tines and at least one spade implement.

13. The rake according to claim 12, wherein the spade implement is tapered to a thin outside edge;

14. The rake according to claim 12, wherein the spade implement is welded to one of the tines.

15. The rake according to claim 12, wherein the spade implement is formed integrally with one of the tines.

16. The rake according to claim 12, wherein the tines has an average width and wherein the spade implement at its widest point is at least 3 times the average width of the tines.

17. The rake according to claim 12, wherein the spade implement has a generally triangular portion.

18. The rake according to claim 12, wherein the spade implement has a generally semicircular portion.
